(19) United States
(12) Patent Application Publication
(10) Pub. No.: US 2012/0246838 A1
(43) Pub. Date: Oct. 4, 2012

(54) METHOD FOR REDUCING WRINKLES USING A FABRIC CARE COMPOSITION

(75) Inventors: Raul Garduno, Mexico D.F. (MX); Javier Tovar, Iztacalco (MX); Alain Jacques, Blegny (BE); Regis Cesar, Villers-le-Bouillet (BE); Ana Acosta, Mexico D.F. (MX); Amit Sachdev, Mexico D.F. (MX)

(73) Assignee: Colgate-Palmolive Company, New York, NY (US)

(21) Appl. No.: 13/382,950

(22) PCT Filed: Jul. 8, 2010
(86) PCT No.: PCT/US2010/041373

§ 371 Date: May 2, 2012

Related U.S. Application Data
(60) Provisional application No. 61/224,300, filed on Jul. 9, 2009.

(51) Int. Cl. C11D 3/60; D06M 15/643

(52) U.S. Cl. 8/137; 510/516

(57) ABSTRACT

There is provided a fabric conditioner that reduces wrinkle formation in laundered garments. There is further provided a method for reducing the occurrence of wrinkles in laundered garments.

### CROSS REFERENCE TO RELATED APPLICATIONS

This application claims priority to U.S. Provisional Patent Application No. 61/224,300, which was filed on 9 Jul. 2009, which is incorporated herein by reference.

### BACKGROUND

When garments are laundered, wrinkles are formed during the washing and drying steps. Although wrinkles can be removed by ironing or pressing the garments, ironing is labor and time intensive. There have been many attempts to prevent formation of wrinkles during the laundering processes. Known attempts to reduce wrinkles by means of including wrinkle-reducing additives in laundry detergents or fabric softeners. Such additives include aminosilicones, and curable aminosilicones. However, each of these ingredients has drawbacks. For example, aminosilicones can cause yellowing, and curable aminosilicones require the heat to reduce wrinkles.

Casual clothing items such as denim jeans are frequently laundered, and garments produced from heavy fabrics, such as denim, are particularly laborious and time-consuming to iron. Accordingly, having means for reducing wrinkles without the need for ironing is highly desirable for such casual clothing items. There is a need for an effective and efficient means for eliminating or reducing wrinkles in garments, especially for casual wear garments, while the garments are washed and dried.

### SUMMARY

A method laundering clothes to minimize wrinkles. The method includes the steps of washing the clothes in a washing procedure, and then applying a fabric conditioner to the washed clothing. The fabric conditioner contains a fatty ester quaternary ammonium and a protein-silicone copolymer, and is adapted for reducing wrinkles on laundered garments having a fabric weight of at least 250 g/m² (7.5 ounce per square yard) and up to 600 g/m². Desirably, the garment has less than 40%, preferably less than 30%, of its surface area covered by more than one layer of fabrics that are attached by stitches.

The invention further provides a fabric conditioner that reduces or minimizes wrinkles in laundered garments while providing softening properties to the clothes. The fabric conditioner is particularly adapted to reduce wrinkles in garments produced from a fabric that has a weight of at least 250 g/m² and up to 600 g/m².

The fabric conditioner may contain 0.5 to 50 weight % of a fabric softening agent, such as a fatty ester quaternary ammonium, and 0.1 to 2 weight % of the protein-silicone copolymer, based on the total weight of the composition, and the fabric softening agent may be a diester ditallow diethyl ammonium salt or a diester ditallow dimethyl ammonium salt. Desirably, the composition reduces wrinkle formation in the laundered garment by at least 50%, more preferably at least 60%, even more preferably at least 70%, compared to the garment laundered without a softening composition.

### DETAILED DESCRIPTION

As used throughout, ranges are used as a shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material unless specified otherwise.

The term laundering encompasses any method of cleaning a fabric. Generally, a fabric can be cleaned by washing with water, either in a washing machine or by hand, or cleaning with a dry cleaning composition, which uses a non-water solvent.

The term fabric conditioner indicates a composition that can condition a fabric. This term includes fabric softeners. Fabric softeners include materials that soften fabrics.

AI refers to the active weight of the combined amounts for monoesterquat, diesterquat, and triesterquat.

This invention provides a method for reducing wrinkles that may be formed when garments are washed and dried. The method includes the step of contacting the garments with a fabric care composition, such as fabric conditioner, that contains a quaternary ammonium softening active and a protein-silicone copolymer. The method is particularly directed to reducing wrinkles for garments produced from a heavy fabric. A heavy fabric suitable for the garments of the present invention includes a fabric having a weight of at least 250 g/m² and up to 600 g/m², preferably 270 g/m² to 550 g/m², more preferably 300 g/m² to 500 g/m². Typically, a heavy fabric is produced by a weaving pattern such as denim, twill, khaki, or duck. The method is also directed to treating garments having less than 40% of their surface area covered by overlapping areas of more than one layer of fabric that are attached by stitches. The stitched overlapping area is preferably 5% to 30%, and more preferably 10% to 25%. The fabric softening reduces wrinkle formation in laundered garments produced from a heavy fabric by at least 50%, more preferably at least 60%, even more preferably at least 70%, compared to the garment laundered without a softening composition.

The fabric care composition, preferably a softening composition, contains a cationic softening active. A suitable cationic softening active is a fatty ester quaternary ammonium compound. The fatty ester quaternary ammonium compound having the formula:

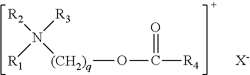

wherein R₄ represents an aliphatic hydrocarbon group having from 8 to 22 carbon atoms, R₂ and R₃, independently, represent (CH₁)ₛ—R₅ where R₅ represents an alkoxy carbonyl group containing from 8 to 22 carbon atoms, benzyl, phenyl, (C1-C4)-alkyl substituted phenyl, OH or H; R₁ represents (CH₂)ₜR₆ wherein R₆ represents benzyl, phenyl, (C1-C4)-alkyl substituted phenyl, OH or H; q, s, and t, each independently, represent an integer from 1 to 3; and X⁻ is a softener compatible anion, including a halogen, e.g., chloride, methyl sulfate, or ethyl sulfate. Suitable examples of the quaternary ammonium compounds include diester dialkyl dimethyl ammonium salts, such as, diester ditallow dimethyl ammonium chloride, and diester ditallow dimethyl ammonium methyl sulfate; diester dialkyl diethyl ammonium salts, such as diester ditallow diethyl ammonium methyl sulfate, diester ditallow ethyl methyl ammonium methyl sulfate; and mixtures thereof. Suitable quaternary ammonium compounds may also contain quaternized mono-, or tri-hydrocarbyl esters of an alkanol amine, and mixtures thereof. A suitable alkanol amine includes triethanolamine, and suitable quaternary ammonium compounds include tallowyl triester ethanol ammonium chloride, tallowyl triester ethanol ammonium sulfate, tallowyl monoester diethanol ammonium chloride, and tallowyl monoester diethanol ammonium sulfate. Other quaternary ammonium compounds with substituted or unsubstituted hydrocarbyl groups, such as stearic, palmitic, myristic fatty acid groups that four an ester with an alkanol amine, are also suitable. The fabric conditioner contains 1 to 50 weight %, based on the total weight of the composition, preferably 2 to 35 weight %, more preferably 3 to 20 weight %, even more preferably 6 to 10 weight %, most preferably 8 to 9 weight %, of a cationic softening active based on the active weight of the material.

The fabric conditioner contains a protein-silicone copolymer. The term protein as used herein refers to a hydrolyzed protein. The term silicone as used herein includes a silane or siloxane. The protein-silicone copolymer has the silicone component bonded to amino groups of the protein component. The copolymer can be prepared by covalently attaching organofunctional silane or siloxane compounds to the protein amino groups to form polymer molecules including protein-silicone cross-linking. The average molecular weight of the protein component may be from 500 to 500,000 daltons, preferably from 1,000 to 20,000 daltons. Exemplary suitable protein-silicone copolymers are disclosed in EP 540357 and WO03/078503.

Suitable copolymers include copolymers of the general formula:

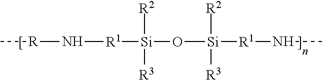

wherein R is the residue of a hydrolyzed protein R—NH₂; each R¹ is, independently, the residue of an organofunctional silane HR¹—Si (R^{2′})(R^{3′})—OH, wherein R^{2′} and R^{3′} are independently methyl, hydroxy, alkoxy having 1 to 6 carbon atoms; R² and R³ are each independently methyl, hydroxy, alkoxy having 1 to 6 carbon atoms or a residue of a compound of formula (A) or (B):

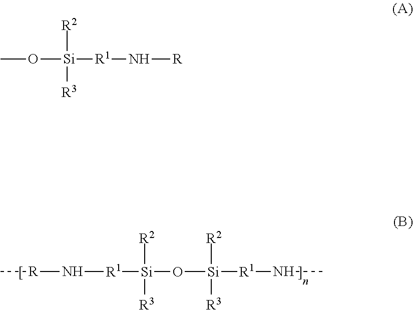

wherein R, R¹, R² and R³ are each independently as defined above; and n corresponds to the number of reacted amino groups, preferably in the range of from 1 to 100, having 0.1 to 0.4 silane molecule per reactive amino group of the protein. R is preferably the residue of hydrolyzed vegetable protein, such as hydrolyzed wheat or potato protein, especially wheat protein. The nature of the group R¹, which is the residue of the organofunctional silane used for reaction with the protein component to form the copolymer, depends on the nature of the functional group originally present in the organofunctional silane. For example, when the functional group originally present in the organofunctional silane was an acyl halide, the group R¹ will typically contain a carbonyl group bonded directly to the nitrogen atom of the protein residue. Similarly, when the functional group originally present in the organofunctional silane was a sulphonyl halide, the group R¹ will typically contain a sulfonyl group bonded directly to the nitrogen atom of the protein residue. Preferably the group R¹ is derived from reaction of an organofunctional silane containing an epoxide group as the functional group. In this case, in the final copolymer compound, the group R¹ will contain a moiety of formula-CH₂—CH(OH)—, the methylene part of which is bonded directly to the nitrogen atom of the protein residue. Preferably the group R¹ is an alkylen group having from 1 to 10 carbon atoms which may be interrupted by one or more oxygen atoms and may be substituted by one or more groups selected from hydroxy groups, halogen atoms, alkyl groups having from 1 to 6 carbon atoms and alkoxy groups having 1 to 6 carbon atoms. Suitable R¹ includes —(CH₂)₃—O—CH₂—CHOH—CH₂—, or —(CH₂)₃—CH(CH₂—CO₂H)—CO—.

The copolymer preferably includes a compound of formula (C):

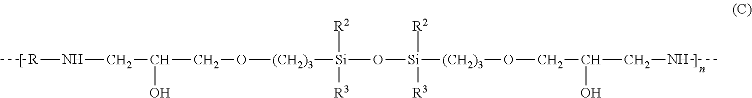

wherein R is a residue of hydrolyse wheat or potato protein; R² and R³ are each other than methyl; and n is 1 to 4, preferably 2. Suitable protein-silicone copolymers for the present invention are commercially available, for example, from Croda Chemicals under the trade names, COLTIDE™ HSi and CRODASON™ W. Particularly suitable is COLTIDE HSi. The fabric conditioner contains 0.02 to 0.5 weight %, based on the total weight of the composition, preferably 0.03 to 0.25 weight %, more preferably 0.04 to 0.2 weight %, most preferably 0.05 to 0.15 weight %, of the protein-silicone copolymer. The weight of the protein-silicone copolymer is based on the as supplied weight.

In one embodiment, the composition contains 8.3 weight % of the esterquat and 0.45 weight % of the protein-silicone copolymer. In another embodiment, the composition contains 2.8 weight % of the esterquat and 0.8 weight % of the protein-silicone copolymer. In another embodiment, the composition contains 6.4 weight % of the esterquat and 0.25 weight % of the protein-silicone copolymer. In another embodiment, the composition contains 6.4 weight % of the esterquat and 0.45 weight % of the protein-silicone copolymer. In another embodiment, the composition contains 10.67 weight % of the esterquat and 0.45 weight % of the protein-silicone copolymer.

The fabric conditioner may additionally contain a thickener. A suitable thickener is a water-soluble cross-linked cationic vinyl polymer which is cross-linked using a cross-linking agent of a difunctional vinyl addition monomer at a level of from 70 to 300 ppm, preferably from 75 to 200 ppm, and most preferably of from 80 to 150 ppm. These polymers are further described in U.S. Pat. No. 4,806,345, and other polymers that may be utilized are disclosed in WO 90/12862. Generally, such polymers are prepared as water-in-oil emulsions, wherein the cross-linked polymers are dispersed in mineral oil, which may contain surfactants. During finished product making, in contact with the water phase, the emulsion inverts, allowing the water soluble polymer to swell. The most preferred thickener for use in the present invention is a cross-linked copolymer of a quaternary ammonium acrylate or methacrylate in combination with an acrylamide comonomer. The thickener required in accordance with the present invention provides fabric conditioners showing long term stability upon storage and allows the presence of relatively high levels of electrolytes without affecting the composition stability. Besides, the fabric conditioners remain stable when shear is applied thereto.

The fabric conditioner may further include a chelating compound. Suitable chelating compounds are capable of chelating metal ions and are present at a level of at least 0.001%, by weight, of the fabric conditioner, preferably from 0.001% to 0.5%, and more preferably 0.005% to 0.25%, by weight. The chelating compounds which are acidic in nature may be present either in the acidic form or as a complex/salt with a suitable counter cation such as an alkali or alkaline earth metal ion, ammonium or substituted ammonium ion or any mixtures thereof. The chelating compounds are selected from among amino carboxylic acid compounds and organo aminophosphonic acid compounds, and mixtures of same. Suitable amino carboxylic acid compounds include: ethylenediamine tetraacetic acid (EDTA); N-hydroxyethylenediamine triacetic acid; nitrilotriacetic acid (NTA); and diethylenetriamine pentaacetic acid (DEPTA). Suitable organo aminophosphonic acid compounds include: ethylenediamine tetrakis (methylenephosphonic acid); 1-hydroxyethane 1,1-diphosphonic acid (HEDP); and aminotri (methylenephosphonic acid).

The fabric conditioner may contain from 0.01% to 3%, preferably 0.05% to 2%, more preferably 0.1% to 1.5% by weight of the composition, of an antifoam agent. Suitable antifoam agents include any known antifoam compound, including, for example silicone antifoam compounds, alcohol antifoam compounds like 2-alkyl alknol antifoam compounds, fatty acids, paraffin antifoam compounds, and mixtures thereof. Particularly preferred antifoam compounds for use herein are silicone antifoam compounds defined herein as any antifoam compound including a silicone component. Such silicone antifoam compounds also typically contain a silica component. The silicone component includes a variety of relatively high molecular weight polymers of siloxane units and hydrocarbyl group of various types such as polyorganosiloxane oils, e.g., polydimethyl-siloxane, dispersions or emulsions of polyorganosiloxane oils or resins, and combinations of polyorganosiloxane with silica particles, in which the polyorganosiloxane is chemisorbed or fused onto the silica. Antifoam compounds are well known in the art and are, for example, disclosed in U.S. Pat. No. 4,265,779, issued May 5, 1981 to Gandolfo et al and European Patent Application No. 89307851.9, published Feb. 7, 1990, by Starch, M. S. Other silicone antifoam compounds are disclosed in U.S. Pat. No. 3,455,839 which relates to compositions and processes for defoaming aqueous solutions by incorporating therein small amounts of polydimethylsiloxane fluids. Mixtures of silicone and silanated silica are described, for instance, in German Patent Application DOS 2,124,526. Examples of suitable silicone antifoam compounds are the combinations of polyorganosiloxane with silica particles commercially available from Dow Corning, Wacker Chemie and General Electric.

The fabric conditioner of the present invention may include an optional dispersant for suspending materials in the rinse and inhibiting their deposition on the laundered fabrics. Dispersing agents can advantageously be utilized at a level 0% to 7%, more preferably 0.1% to 5%, and most preferably 0.2% to 3% by weight, in the compositions. Suitable dispersing agents include nonionic surfactants, which include addition products of ethylene oxide and, optionally, propylene oxide, with fatty alcohols, fatty acids, fatty amines, and the like. They are referred to herein as ethoxylated fatty alcohols, ethoxylated fatty acids, and ethoxylated fatty amines. Any of the ethoxylated materials of the particular type described hereinafter can be used as the nonionic surfactant. Suitable compounds are surfactants of the general formula:

R⁵—Y—(C₂H₄O)_{z}—C₂H₄OH

wherein R⁵ is selected from the group consisting of primary, secondary and branched chain alkyl and/or acyl and/or acyl hydrocarbyl groups; primary, secondary and branched chain alkenyl hydrocarbyl groups, and primary, secondary and branched chain alkyl- and alkenyl substituted phenolic hydrocarbyl groups; said hydrocarbyl groups having a hydrocarbyl chain length of 8 to 20, preferably 9 to 18 carbon atoms. In the general formula for the ethoxylated nonionic surfactants herein Y is typically —O—, —C(O)O—, preferably —O—, and in which R⁵, when present, have the meanings given hereinbefore, and z is 1 to 30, more preferably 7 to 25.

The fabric conditioner may optionally contain components that are conventionally included in fabric conditioning compositions such as, perfumes, surfactant concentration aids, emulsifiers, colourants, preservatives, optical brighteners, natural and/or synthetic extracts, fluorescers, hydrotropes, anti-redeposition agents, anti-shrinking agents, anti-spotting agents, anti-corrosion agents, drape imparting agents, anti-static agents, ironing aids and mixtures thereof.

The fabric conditioner of present invention highly suitable for reducing wrinkle formation in laundered and dried garments, preferably in heavy fabric garments, such that casual garments can be laundered and worn without the need for laborious ironing the garments.

### EXAMPLES

### Example 1

### Fabric Softener

Fabric softener compositions are prepared with the following ingredients.

TABLE 1

| | Composition | | | | | | |
|---|---|---|---|---|---|---|---|
| | 1 | 2 | 3 | 4 | 5 | 6 | 7 |
| C14-C15 alcohol | 0.3 | 0.3 | 0.3 | 0.3 | 0.3 | 0.3 | 0.3 |
| EO20: 1 | | | | | | | |
| COLTIDE ™ HSi | 0.45 (0.11) | 0.25 (0.06) | 0 | 0.45 (0.11) | 0.45 (0.11) | 0.25 (0.06) | 0 |
| Protein-silicone | | | | | | | |
| copolymer (solid) | | | | | | | |
| Lactic acid | 0.06 | 0.06 | 0.06 | 0.06 | 0.06 | 0.06 | 0.06 |
| Dequest ™ 2000 | 0.1 | 0.1 | 0.1 | 0.1 | 0.1 | 0.1 | 0.1 |
| Amino trimethyl | | | | | | | |
| phosphonic acid | | | | | | | |
| Tetranyl L90 | 9.1 (8.1) | 8.1 (7.4) | 11.7 (10) | 9.2 (8.3) | 7.1 (6.4) | 7.1 (6.4) | 7.1 (6.4) |
| quaternized tallow | | | | | | | |
| ester ammonium | | | | | | | |
| (active) | | | | | | | |
| Perfume | 1 | 1 | 1 | 1 | 1 | 1 | 1 |
| Flosoft ™ DP-200 | 0.3 | 0.3 | 0.3 | 0.3 | 0.3 | 0.3 | 0.3 |
| cationic acrylate | | | | | | | |
| thickener from SNF | | | | | | | |
| Floerger | | | | | | | |
| Simethicone antifoam | 0.4 | 0.4 | 0.4 | 0.4 | 0.4 | 0.4 | 0.4 |
| Water | Balance | Balance | Balance | Balance | Balance | Balance | Balance |

Method of Softener Preparation:

Water is heated to 65° C., and phosphonic acid and the protein-silicone copolymer are added with stirring. Separately, quaternized tallow ester ammonium is heated to 65° C. with stirring. Slowly the quaternized ammonium is added to the acid-water solution and mixed for 10 minutes. The mixture is cooled to 35° C. and lactic acid is added. The thickener is then added with stirring. The mixture is stirred for additional 10 minutes.

### Example 2

### Wrinkle Evaluation

100% cotton denim jeans having a fabric weight of 400 to 500 g/m² and a long sleeve 100% cotton dress shirt having a fabric weight of 190 g/m² are washed in an automatic washing machine using Compositions 2 and 3 of Example 1 in the fabric softener cycle. The commercial fabric softener usage instructions are followed to dose the fabric softener compositions. As a comparison, another set of the above-described garments are washed without adding the fabric treatment composition of the present invention. The garments are removed from the washing machine and hang dried in the ambient condition. A panel of six evaluators is solicited for its visual evaluation of the dried garments for the amount of wrinkles formed on each garments and its opinion on whether there is a need for ironing the garments. The visual wrinkle evaluation is carried out by assigning 1 for the least wrinkled and 3 for the most wrinkled. Table 2 lists the cumulative sum of all the assigned numbers for the washed garments.

TABLE 2
Wrinkle Visual Evaluation

| Garment type | Composition 2 | Composition 3 | No fabric treatment |
|---|---|---|---|
| Jeans | 14 | 25 | 21 |
| Dress Shirts | 15 | 18 | 19 |

TABLE 3
Need for Ironing (response of no need to iron %)

| Garment type | Composition 2 | Composition 3 | No fabric treatment |
|---|---|---|---|
| Jeans | 80% | 0% | 50% |
| Dress Shirts | 0% | 10% | 0% |

As can be seen from the above, a fabric care composition of the present invention significantly reduces wrinkle formation in garments produced from heavy weight fabrics. The fabric care composition significantly diminishes the need to iron casual wear garments of heavy weight, significantly reducing the laborious chore.

### Example 3

### Wrinkles on Fabrics

20 cm² square swatches are prepared and washed with an automatic washing machine using Composition 1 of Example 1 in the fabric softener cycle. As a comparison, another set of the swatches are also washed but without adding the fabric treatment composition of the present invention. The washing machine is stopped just before the last spinning cycle, and the swatches are removed from the washing machine. Each swatch is folded twice length wise, and hand wring to remove water. The wrung swatch is opened and shaken three times by grabbing two corners of the swatch. Each dried swatch is evaluated for the number of visually perceptive wrinkles within a 6 cm² circle at the center of the swatch. For each formulations, forty five swatches for each fabric are tested. Table 4 lists the average number of wrinkles.

TABLE 4

| | | Composition 1 | No fabric | % wrin- |
|---|---|---|---|---|
| | Fabric | (average | treatment | kle |
| | weight | number | (average number of | reduc- |
| Garment type | (g/m²) | of wrinkles) | wrinkles) | tion |
| Denim (100% | 466 | 6.0 | 25.7 | 76% |
| cotton) | | | | |
| Khaki (100% | 252 | 6.3 | 19.4 | 68% |
| cotton) | | | | |

### Example 3

Compositions 4 to 7 were evaluated in panel tests that had 30 to 32 panelists evaluating the garments for the appearance of wrinkles. The garments are assessed on a 5 point scale with 1 being not at all wrinkled and 5 being extremely wrinkled. Panelists stand about 1.5 meters from the garment in a well lighted room. The results below are the average rating for the garments in different conditions. Jeans (100% cotton) and Shirts (65% polyester and 35% cotton) are washed and fabric treated with compositions 4 to 7. There are 192 jeans and 192 shirts evaluated. Half of the shirts and jeans were line dried (92) and half were dryer dried (92). The data in the table below is based on evaluations after 3 cumulative washing cycles described below. The lower number indicates less wrinkles.

In the first wash, the garments are washed in an automatic front load washer using 45 liters of water with a hardness of 100 ppm at 25° C., 1.8 kg of garments, and 30 g of Axion laundry detergent from Mexico. A second wash is conducted with the same conditions without detergent. A third wash is conducted using 66 liters of room temperature (about 23-25° C.) water, 2.8 kg of garments, 42.5 g Tide liquid detergent from the U.S., and 110 ml of composition 4, 5, 6, or 7. For dryer drying, the garments are dried on high for 60 minutes.

| | Composition | | | | Wash without |
|---|---|---|---|---|---|
| | 4 | 5 | 6 | 7 | softener |
| Jeans total | 2.1 | 2.1 | 1.9 | 2.17 | 2.24 |
| Jeans line dry | 2.29 | 2.61 | 2.59 | 2.52 | 2.75 |
| Jeans dryer | 2.18 | 1.86 | 1.49 | 2.08 | 2.03 |
| Shirts total | 2.95 | 2.64 | 2.66 | 2.80 | 3.12 |
| Shirts line dry | 3.86 | 3.45 | 3.28 | 3.53 | 3.58 |
| Shirts dryer | 2.04 | 1.83 | 2.24 | 2.07 | 2.67 |

Compositions 5, 6, and 7 are the same except for the level of the Coltide™ HSi protein-silicone copolymer. In dryer drying, the addition of the Coltide™ HSi protein-silicone copolymer reduced the amount of wrinkles in the garment.

What is claimed is:

1. A method for reducing wrinkles from a heavy fabric garment while laundering, comprising the steps of washing the garment in a washing procedure, and applying a fabric conditioner to the garment, the fabric conditioner comprising a fatty ester quaternary ammonium, and a protein-silicone copolymer, wherein the garment is produced from a fabric having a fabric weight of at least 250 g/m².

2. The method of claim 1, wherein the fabric conditioner comprises 1 to 50 weight % of the fatty ester quaternary ammonium compound and 0.02 to 0.5 weight % of the protein-silicone copolymer, based on the total weight of the composition.

3. The method of any preceding claim, wherein the fabric conditioner is applied to the washed garment.

4. The method of any preceding claim, wherein the fatty ester quaternary ammonium comprises a diester ditallow diethyl ammonium salt or a diester ditallow dimethyl ammonium salt.

5. The method of any preceding claim, wherein the softening composition reduces at least 50% of wrinkles compared to the same garment laundered and dried without the softening composition.

6. The method of any preceding claim, wherein the softening composition comprises 6 to 10 weight % of the fatty ester quaternary ammonium compound, and 0.05 to 0.15 weight % of the protein-silicone copolymer, based the total weight of the composition.

7. The method of any preceding claim, wherein the laundering procedure comprises a washing step and a separate rinsing step, and wherein the protein-silicone copolymer is applied in the rinsing step.

8. The method of claim 7, wherein the washing step is performed automatically by a washing machine and the rinsing step is performed manually.

9. The method of claim 7, wherein the laundering procedure is performed in an automatic washing machine that has a washing step and a rinsing step, wherein the fabric conditioner is applied in the rinsing step.

10. The method of any preceding claim further comprising drying the heavy fabric garment in a dryer.

11. An anti-wrinkle fabric conditioner for a heavy fabric garment comprising:
a) 0.5% to 50% by weight of a cationic softening agent,
b) 0.02% to 0.5% by weight of a protein-silicone copolymer,
c) a fragrance, and
d) water, wherein the softening composition reduces at least 50% of wrinkles on a garment that is produced from a fabric having a fabric weight of at least 250 g/m².

12. The composition of claim 11, wherein the softening agent comprises a fatty ester quaternary ammonium compound.

13. The composition of any of claims 11 to 12, wherein the softening agent comprises a diester ditallow diethyl ammonium salt or a diester ditallow dimethyl ammonium salt.

14. The composition of any of claims 11 to 13, wherein the protein-silicone copolymer comprises a copolymer having the formula: 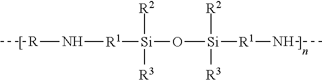
wherein R is the residue of a hydrolyzed protein R—NH₂; each R¹ is, independently, the residue of an organofunctional silane HR¹—Si (R^{2′}) (R^{3′})—OH, wherein R^{2′} and R^{3′} are independently methyl, hydroxy, alkoxy having 1 to 6 carbon atoms; R² and R³ are each independently methyl, hydroxy, alkoxy having 1 to 6 carbon atoms or a residue of a compound of formula (A) or (B): 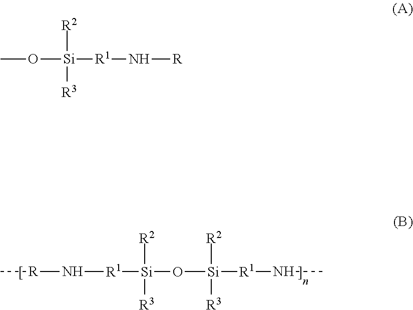
wherein R, R¹, R² and R³ are each independently as defined above; and n corresponds to the number of reacted amino groups having 0.1 to 0.4 silane molecule per reactive amino group of the protein.

15. The composition of any of claims 11 to 14, wherein the softening composition comprises 6 to 10 weight % of the fatty ester quaternary ammonium, and 0.05 to 0.15 weight % of the protein-silicone copolymer, based on the total weight of the composition.
